(19) United States
(12) Patent Application Publication
(10) Pub. No.: US 2026/0120671 A1
(43) Pub. Date: Apr. 30, 2026

(54) POLYPHONIC PICKUP FOR STRINGED MUSICAL INSTRUMENT

(71) Applicant: Overman LLC, St. Paul, MN (US)

(72) Inventors: William Wyatt OVERMAN, St. Paul, MN (US); Jonathan P. FORSYTHE, St. Paul, MN (US)

(73) Assignee: Overman LLC, St. Paul, MN (US)

(21) Appl. No.: 19/060,456

(22) Filed: Feb. 21, 2025

Related U.S. Application Data
(63) Continuation-in-part of application No. 18/934,201, filed on Oct. 31, 2024.

(51) Int. Cl. G10H 3/18

(52) U.S. Cl. CPC G10H 3/181; G10H 3/185; G10H 2220/465; G10H 2220/485; G10H 2220/525

(57) ABSTRACT

A polyphonic pickup system for a stringed musical instrument includes one or more user-input devices collectively defining a plurality of distinct selectable configurations, enabling the user to direct audio signals corresponding to different subsets of the instrument's strings to different audio-output channels for directing audio signals originating from different individual strings of the instrument.

### TECHNICAL FIELD

The present technology is generally related to stringed musical instruments.

### BACKGROUND

Stereophonic audio (or simply “stereo” audio) involves splitting an audio source into two or more individual electronic signals for output at different physical locations, in order to produce an enhanced “three-dimensional” (3-D) or “surround-sound” characteristic. As one example, a user's left earbud and right earbud can be configured to play a different portion of a song in each ear simultaneously.

### SUMMARY OF THE DISCLOSURE

The techniques of this disclosure generally relate to systems and techniques for incorporating stereophonic audio between different strings of a stringed musical instrument, such as a guitar, bass guitar, cello, ukulele, viola, and the like. Specifically, the systems described herein enable a user to select a desired audio-output channel for any individual string, or group of strings, providing for a uniquely customizable listening experience.

Some examples of the present disclosure include a polyphonic pickup system for a stringed musical instrument, wherein the system includes: two or more audio-output devices; two or more piezoelectric transducers each configured to output a respective electric signal in response to receiving a sonic pressure wave from one or more adjacent strings of the stringed musical instrument; and a user input device defining two or more selectable configurations, the user-input device being conductively coupled between the piezoelectric transducers and the audio-output devices such that each selectable configuration of the user-input device defines a unique electrical connection between the piezoelectric transducers and the audio-output devices.

In some examples of this disclosure, a stringed musical instrument includes a polyphonic pickup system comprising: two or more audio-output devices; two or more piezoelectric transducers each configured to output a respective electric signal in response to receiving a sonic pressure wave from one or more adjacent strings of the stringed musical instrument; and a user input device defining two or more selectable configurations, the user-input device being conductively coupled between the piezoelectric transducers and the audio-output devices such that each selectable configurations of the user-input device defines a unique electrical connection between the piezoelectric transducers and the audio-output devices.

In some examples of this disclosure, a polyphonic-pickup kit includes at least: a transducer saddle, a plurality of piezoelectric transducers; one or more single-pole-double-throw (SPDT) toggle switches; two or more audio-output jacks; and optionally, a Musical Instrument Digital Interface (MIDI) output jack.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a front view of a stringed musical instrument including an integrated polyphonic pickup system.

FIG. 1B is a partial transparent view of the stringed musical instrument of FIG. 1A, showing some example internal components of the polyphonic pickup system.

FIG. 1C is a closeup view of an example of the polyphonic pickup system of FIGS. 1A & 1B.

FIG. 2A shows an example user-input device for the polyphonic pickup system of FIGS. 1A-1C while in a first selectable configuration.

FIG. 2B shows the user-input device of FIG. 2A while in a second selectable configuration.

FIG. 2C shows the user-input device of FIGS. 2A & 2B while in a third selectable configuration.

FIG. 3 is an example wiring diagram for the polyphonic pickup system of FIGS. 1A-1C.

FIG. 4A is a front view of the stringed musical instrument of FIGS. 1A & 1B, illustrating an example in which the polyphonic pickup system includes an optional musical instrument digital interface (MIDI) output device.

FIG. 4B is a partial transparent view of the stringed musical instrument of FIG. 4A, showing some example internal components of the polyphonic pickup system.

FIG. 4C is an example wiring diagram for the polyphonic pickup system of FIGS. 4A & 4B.

FIG. 5A is a front view of the stringed musical instrument of FIGS. 1A & 1B, illustrating an alternate placement for a control panel of the polyphonic pickup system.

FIG. 5B is a partial transparent view of the stringed musical instrument of FIG. 5A, showing some example internal components of the polyphonic pickup system.

FIG. 6 is a front view of the stringed musical instrument of FIGS. 1A & 1B, illustrating another alternate configuration for the control panel of the polyphonic pickup system.

FIG. 7 depicts a example kit for assembling a polyphonic pickup system within a stringed musical instrument.

FIG. 8 is a flowchart illustrating an example process or method for installing a polyphonic pickup system within a stringed musical instrument.

FIG. 9 is a conceptual diagram showing an example of two non-overlapping subsets of strings on a musical instrument.

FIG. 10A is a closeup view of a polyphonic pickup system based on the example string subsets shown in FIG. 9.

FIG. 10B is a wiring diagram providing electronic functionality for the polyphonic pickup system of FIG. 10A.

FIG. 10C is a conceptual diagram showing an example placement of a customized string saddle for the polyphonic pickup system of FIG. 10A.

FIG. 11A is a closeup view of another example polyphonic pickup system based on the example string subsets shown in FIG. 9.

FIG. 11B is a wiring diagram providing electronic functionality for the polyphonic pickup system of FIG. 11A.

FIG. 12A is a closeup view of another example polyphonic pickup system based on the example string subsets shown in FIG. 9.

FIG. 12B is a wiring diagram providing electronic functionality for the polyphonic pickup system of FIG. 12A.

FIG. 12C is a perspective view of a stringed musical instrument integrated with the polyphonic pickup system of FIG. 12A.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

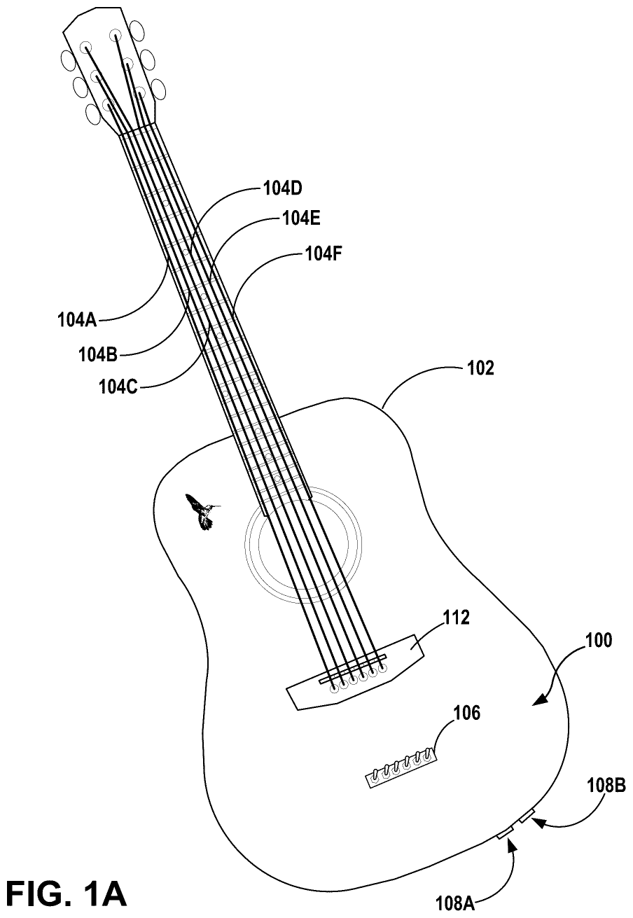

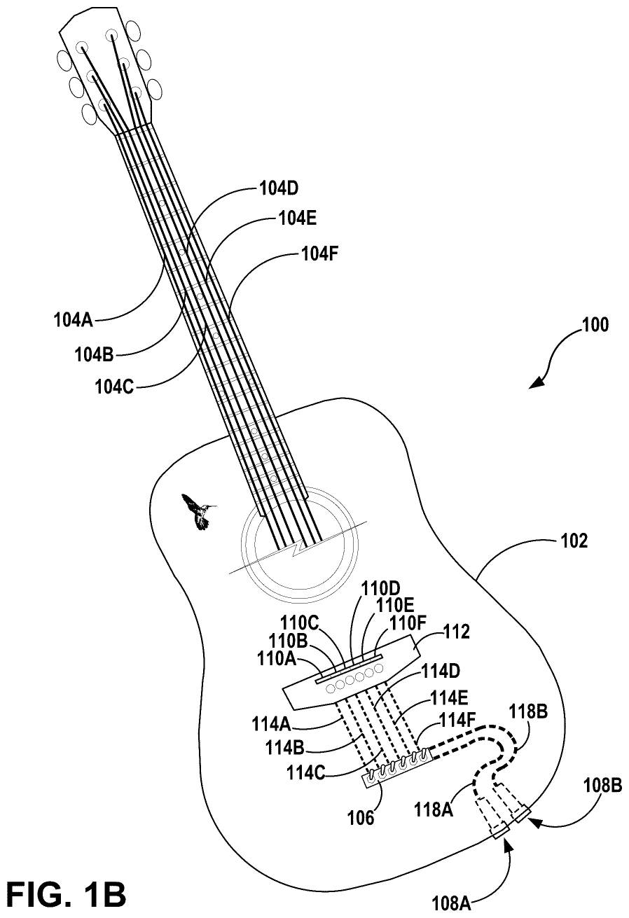

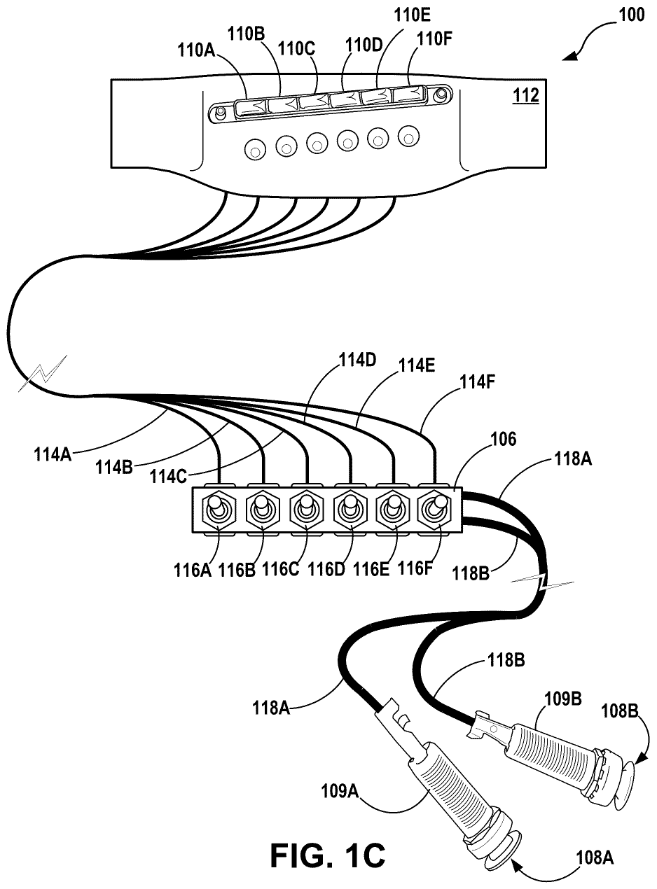

FIG. 1A is a front view of a stringed musical instrument with an integrated polyphonic pickup system 100, in accordance with the techniques of this disclosure. As used herein, the term “polyphonic” refers to the system's ability to provide independent control over multiple (i.e., two or more) sounds or audio signals simultaneously. In particular, the polyphonic pickup systems described herein provide the user with the ability to isolate and transmit the music produced by any two or more different subsets of the set of strings on a musical instrument, up to, and including, each individual string, i.e., independently from every other string.

For instance, in FIG. 1A, the stringed musical instrument is depicted as an acoustic guitar 102 having exactly six strings 104A-104F (collectively, “strings 104”). In this particular example, system 100 is configured to provide the user with individual control over each of the six strings, i.e., independent from the other five strings. Accordingly, polyphonic system 100 constitutes a “hexaphonic” (i.e., six-sound) pickup system.

It is to be understood, however, to those of ordinary skill in the art, that the techniques of this disclosure are similarly applicable to any two or more different subsets of the instrument's strings 104, and further, to virtually any stringed musical instrument having two or more strings. Well-known classes of such instruments include, for instance: bass guitars, ukuleles, cellos, violins, violas, and fiddles (four strings each); banjos (four-to-six strings); mandolins (eight strings); balalaikas (three strings); veenas (four-to-eight strings); harps (nineteen-to-forty-seven strings); and even large, stationary stringed instruments such as pianos (230 strings).

Functionally, polyphonic pickup system 100 is configured such that a user (e.g., the guitar player) can individually select, for each string 104 of the instrument, a desired audio-output channel from two or more such channels. In this regard, polyphonic pickup system 100 can be considered to be part of a “stereophonic” audio system that additionally includes two or more audio-output devices (not shown), such as speakers, earbuds, or headphones, that may be conductively coupled to the audio-output channels of system 100.

In the particular example depicted, system 100 includes a control panel 106 of user-input device(s) enabling the user to select, whenever desired, either a first (or “left”) audio-output port 108A or a second (or “right”) audio-output port 108B to receive (or “channel”) the electronic audio signal encoding the sound generated by any conceivable subset of strings 104. That is, the “left” subset and the “right” subset can each be: any one individual string 104, any combination or permutation of two or more strings 104, all six of strings 104, or even none of strings 104. For instance, in some examples the input device(s) are each “thirdly” selectable (i.e., define a “third” selectable configuration in addition to “left” and “right”), enabling the user to “mute” the sound from any individual string 104 at will.

FIGS. 1B & 1C illustrate some additional internal components of polyphonic pickup system 100 of FIG. 1A. For instance, system 100 includes two or more audio transducers, or “pickup” devices 110, with each pickup device 110 corresponding to a predetermined (i.e., fixed) subset of the strings 104 of the guitar 102. For instance, in the present example, six pickup devices 110A-110F are aligned within the bridge 112 of the guitar 102, with each pickup device 110 positioned directly underneath a lower end of exactly one of strings 104. Accordingly, this particular configuration defines six non-overlapping subsets of strings, with each subset containing one single string. In further examples described below, pickup devices 110 can be numbered and arranged to provide for any two or more (overlapping or non-overlapping) subsets of strings 104.

In general, each pickup device 110, when positioned immediately adjacent to its corresponding subset of string(s) 104, is configured to generate and output a signal when its subset of string(s) has been plucked and is producing sound. Typically (though not necessarily in all examples), pickup devices 110 each include a piezoelectric transducer that generates an electrical signal in response to the incident pressure wave of sonic energy when its subset of string(s) 104 is plucked. Such transducers can include, for example, disc-type, saddle-type, button-type, bar-type, or braided-rope-type piezoelectric transducers. In other examples, pickup devices can include non-electrical transducers configured to output other types of signals, such as optical signals or electromagnetic (EM) signals.

In the case of piezoelectric-based pickup devices 110, system 100 further includes a plurality of electrically conductive wires 114A-114F, with each conductive wire 114 corresponding to a respective pickup device 110 and its corresponding subset of string(s) 104. In some examples, each conductive wire 114 is integrally formed with its pickup device 110, i.e., wherein the pickup device 110 is non-removably coupled to the proximal end of the wire 114. In other examples, each conductive wire 114 may be electrically coupled (e.g., soldered) to a native conductive wire of the pickup device 110, so as to form an elongating extension of the native wire.

Pickup system 100 further includes one or more user-input devices 116 each defining two or more selectable configurations. That is, each user-input device 116 can be (or can include) any suitable component that is manually adjustable, selectable, convertible, or otherwise manipulable between two or more well-defined states, positions, orientations, or configurations. Various example types of such components include switches, dials, push-buttons, levers, and even digital graphical objects of a graphical user interface (GUI) displayed on a touch-sensitive display (or “touchscreen”).

Regardless of the physical selection mechanism, input device(s) 116 are conductively wired such that each selectable configuration of one input device 116, or each permutation of selectable configurations among multiple input devices 116 (as appropriate), defines a unique, continuous electrical connection between the two or more pickup devices 110, and the two or more audio-output ports 108.

In the particular example shown, system 100 includes six user-input devices 116A-116F, with each user-input device 116 corresponding to a respective conductive wire 114, a respective pickup device 110, and a respective string 104. That is, each user-input device 116 is electrically coupled to the distal end of its corresponding conductive wire 114, thereby establishing a continuous electrical connection to the corresponding pickup device 110.

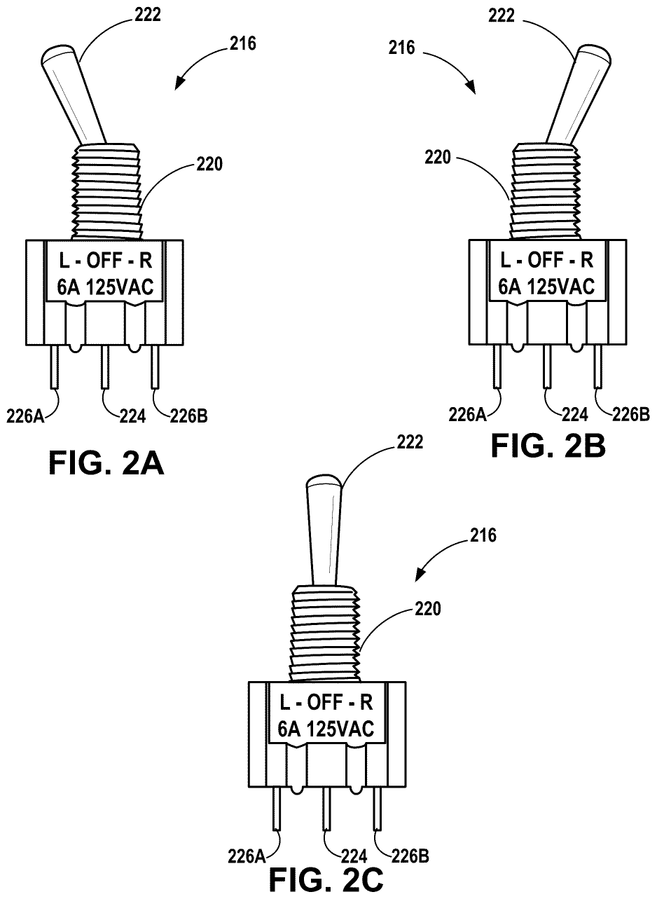

FIGS. 2A-2C illustrate one non-limiting example implementation of user-input device(s) 116. Specifically, one such widely available input device 116 is a single-pole-double-throw (“SPDT”) toggle switch 216, which typically defines three different selectable configurations. As shown, each SPDT toggle switch 216 includes a base portion 220 and an elongated lever or knob 222 extending upward therefrom. The elongated lever or knob 222 is configurable between three different positions or orientations relative to the base: a “left” position (FIG. 2A), a “right” position (FIG. 2B), and a “middle” position (FIG. 2C).

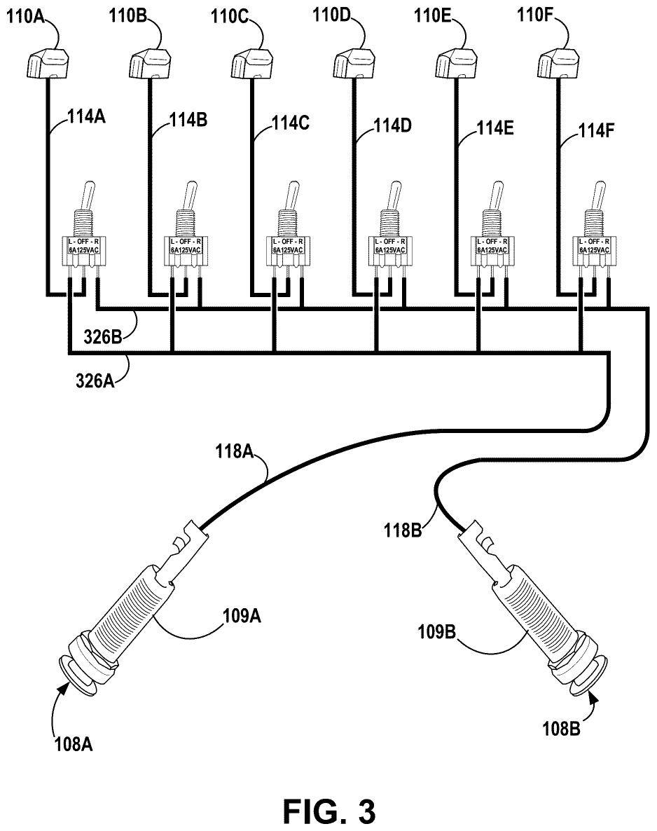

Each SPDT toggle switch 216 further includes one electrical-input prong 224, a “left” electrical-output prong 226A, and a “right” electrical-output prong 226B. Accordingly, FIG. 3 depicts an example electrical-wiring diagram enabling the specific functionality of pickup system 100 of FIGS. 1A-IC.

As shown in FIG. 3, the “left” output prongs 226A are all electrically connected in parallel (connection 326A) such that, when the knob 222 of any toggle switch 216 is in the “left” position (e.g., FIG. 2A), a continuous electrical connection extends between its pickup device 110 and the first (or “left”) output port 108A on audio jack 109A, via output wire 118A.

Similarly, the “right” output prongs 226B are all electrically connected in parallel (connection 326B) such that, when the knob 222 of any toggle switch 216 is in the “right” position (e.g., FIG. 2B), a continuous electrical connection extends between its pickup device 110 and the second (or “right”) output port 108B on audio jack 109B, via output wire 118B. While the knob or lever 222 of any toggle switch 216 is in the “middle” position (e.g., FIG. 2C), the corresponding conductive wire 114 is not coupled to either audio jack 109, thereby functionally “cutting” or “muting” the corresponding string 104 of the guitar 102.

The polyphonic pickup system can include more than two “selectable” audio-output channels, so long as each user-input device 116 defines a corresponding number of selectable configurations to accommodate. For instance, in the case of three selectable audio-output channels, each user-input device 116 must have at least three selectable configurations, as well as a fourth “mute” configuration, if so desired.

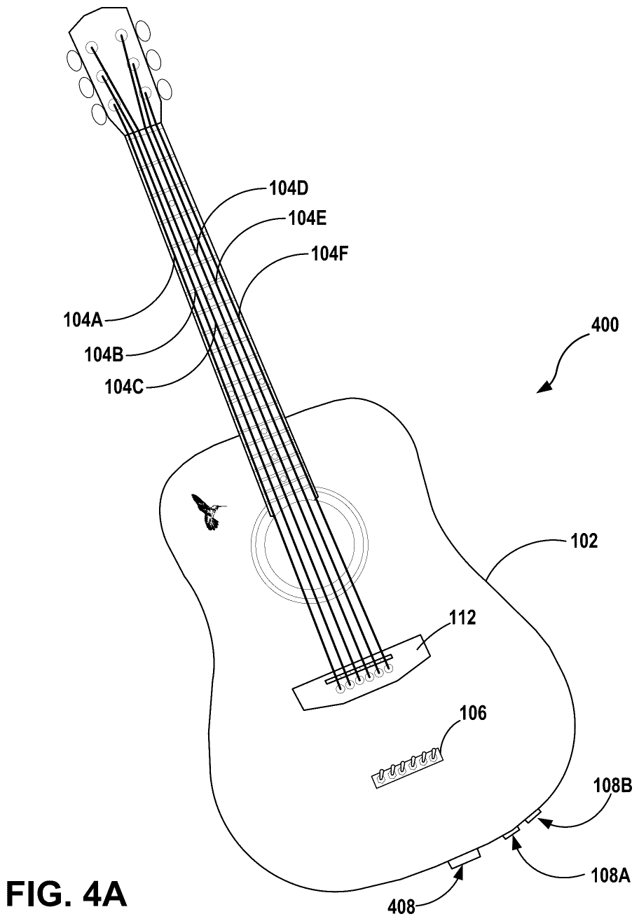

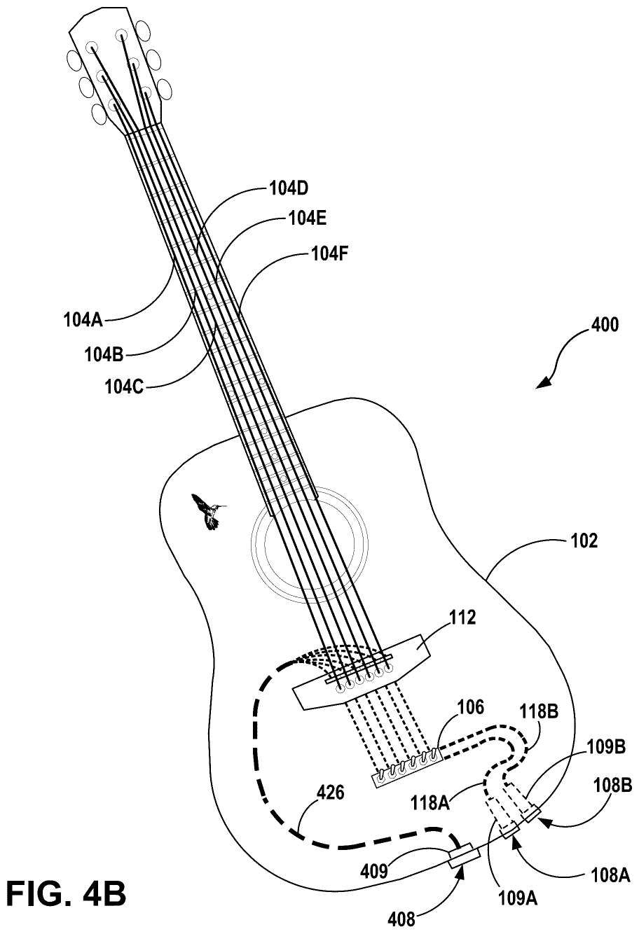

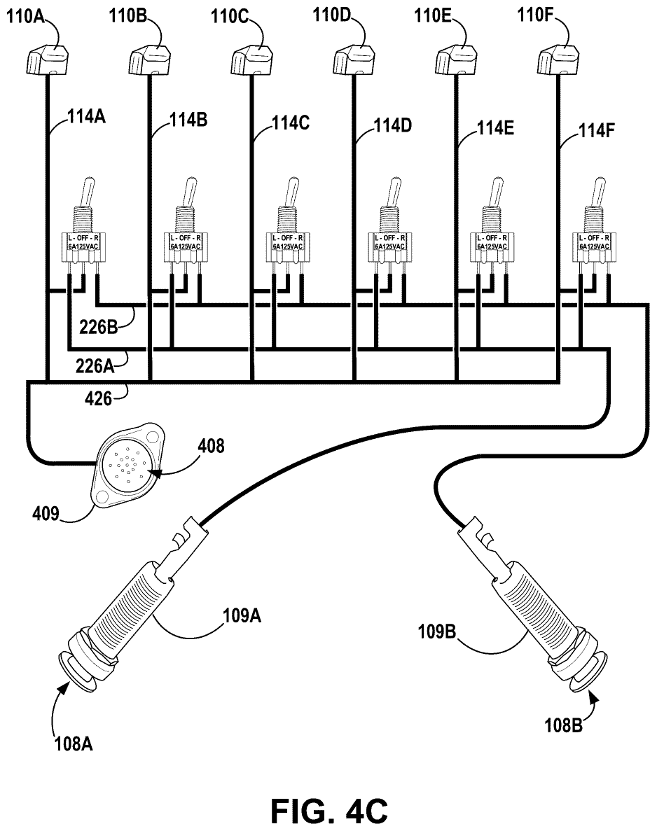

Additionally, or alternatively, the polyphonic pickup system can include one or more “non-selectable” audio-output channels, i.e., that are not selectable and de-selectable at-will via input device(s) 116 of the control panel 106. For instance, FIGS. 4A-4C illustrate an example of polyphonic pickup system 100 (FIGS. 1A-1C) in which the system 400 includes one non-selectable audio-output port 408, in addition to the two selectable output ports 108A and 108B. As shown in FIGS. 4B & 4C, audio jack 409 is directly wired in parallel (connection 426) to all of pickup devices 110, i.e., bypassing the control panel 106 of input devices 110 entirely.

In some implementations, audio jack 409 can include a standardized Musical Instrument Digital Interface (“MIDI”) output port 408. Such devices are configured to be communicatively coupled to a suitable computing device running an instance of music-recording software. In some such examples, the player can use the digital controls provided by the software to perform the same (or substantially similar) functionality as the physical control panel 106.

For instance, when the computing device is similarly connected to the two or more audio-output devices (not shown), such as speakers or headphones, the user can manipulate the digital controls within the music-recording software to “direct” the audio from any conceivable subset of string(s) 104 toward either “virtual” audio channel in addition to, or instead of, using the manual toggles 116/216. Additionally, in some instances of the appropriate recording software, the user can command the program to store one or more of their favorite audio-output permutations (e.g., “LLRLRL,” or “LLLLLR,” etc.) in digital memory for subsequent retrieval, for instance, to rapidly iterate between different preset permutations.

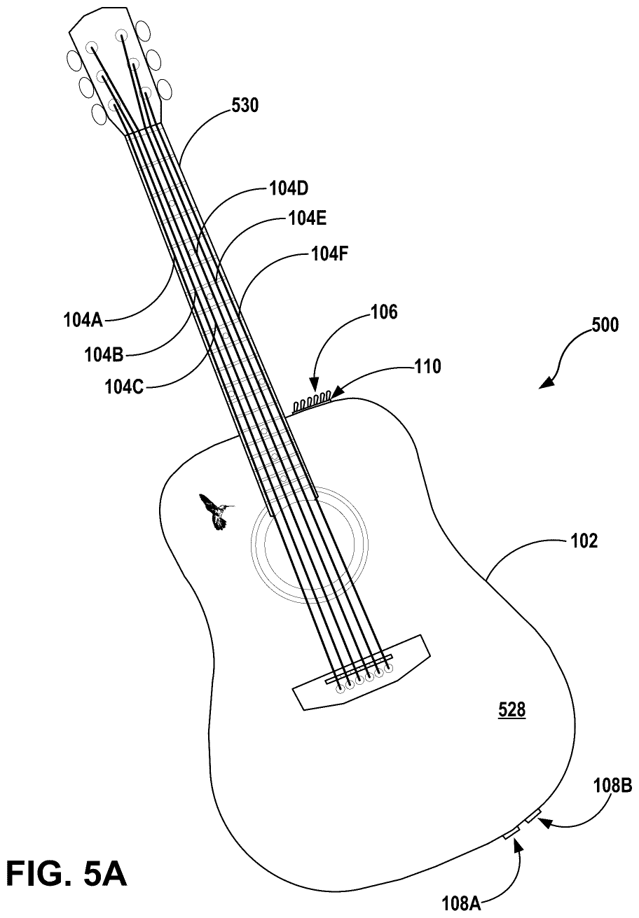

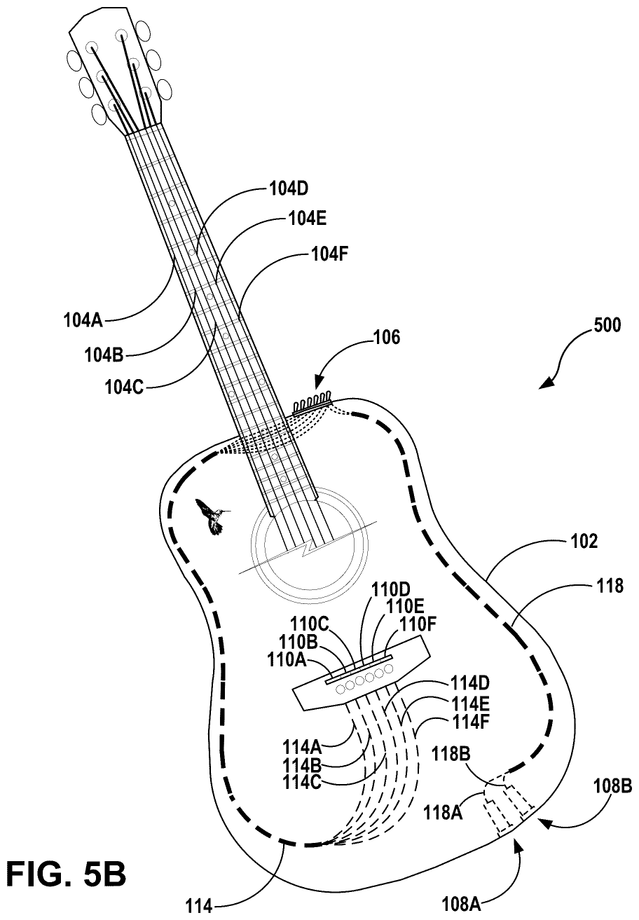

User-input device(s) 110 can assume practically any suitable configuration or orientation relative to the instrument 102. For instance, FIGS. 5A & 5B illustrate another example of polyphonic pickup system 100 of FIGS. 1A-IC with an alternate placement for control panel 106. Specifically, in system 500, the control panel 106 is mounted on the side of the guitar 102 near where the neck 530 attaches to the body 528, rather than on top of the guitar, below the strings. Such modifications can easily be implemented based on user preference, such as case-of-access, provided that the internal wiring is adjusted accordingly, as illustrated in FIG. 5B, and as will be readily understood to those of skill in the art.

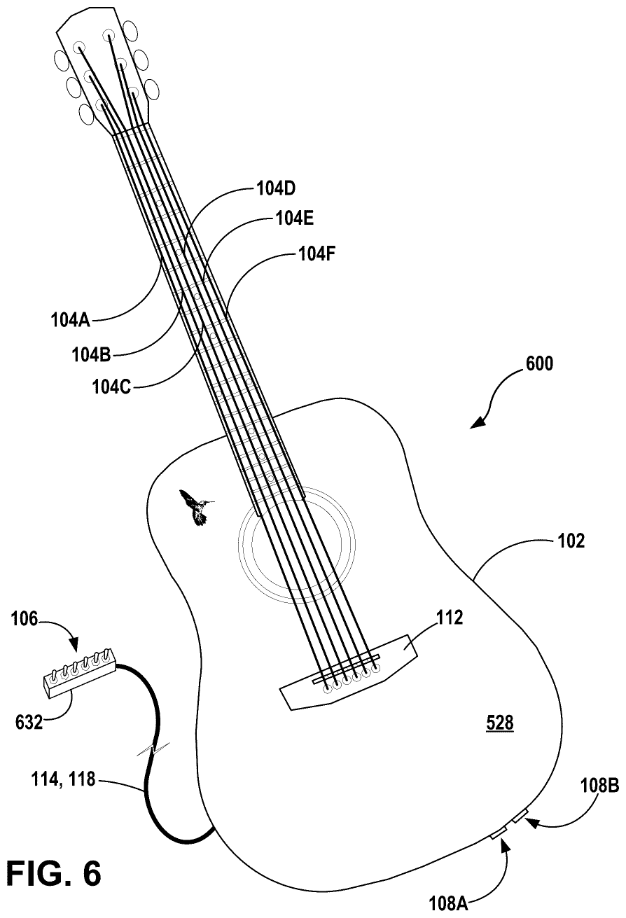

Similarly, FIG. 6 illustrates another example of polyphonic pickup system 100 of FIGS. 1A-IC with an alternate configuration of control panel 106. Specifically, in system 600, the control panel 106 is not externally mounted on the body 528 of the guitar 102, but rather, is incorporated into a “handheld” controller device 632 electronically coupled to the guitar 102 via wiring 114/118 of an appropriate length, as determined by user preference. In other examples of pickup system 600, the controller device 632 can be a fully “remote” control, i.e., configured to wirelessly transmit electromagnetic signals to a counterpart receiver device (not shown) functionally integrated within the body 528 of the guitar 102.

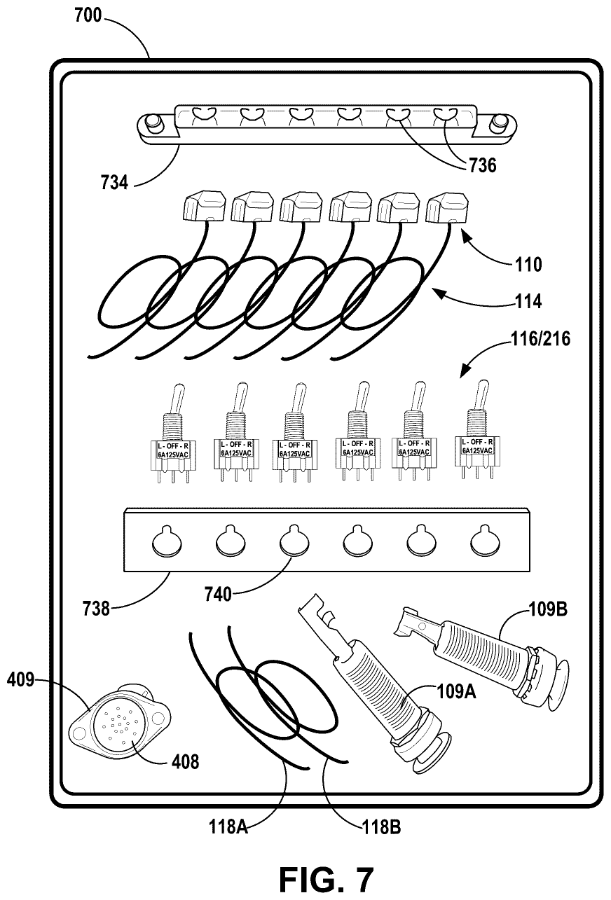

FIG. 7 depicts an example kit 700 for assembling a polyphonic pickup system within a stringed musical instrument 102 (FIG. 1A), in accordance with any or all of the examples described above. As shown in FIG. 7, kit 700 includes: a pickup-transducer saddle 734 defining a number of slots 736 equal to the number of strings 104 of the musical instrument 102; a plurality of pickup devices 110 (e.g., piezoelectric transducers) corresponding to the number of strings 104 of the musical instrument 102; a plurality of electrically conductive wires 114, which may or may not already be conductively integrated with the respective pickup devices 110; a plurality of user-input devices 116, such as SPDT toggle switches 216, corresponding to the number of strings 104 of the musical instrument 102; a rectangular plate 738 defining a number of apertures 740 corresponding to the number of strings 104 of the intended musical instrument 102; and two or more audio jacks 109A, 109B with corresponding output wiring 118A, 118B. In some examples, but not all examples, kit 700 further includes an additional audio jack 409 defining a standard MIDI output port 408.

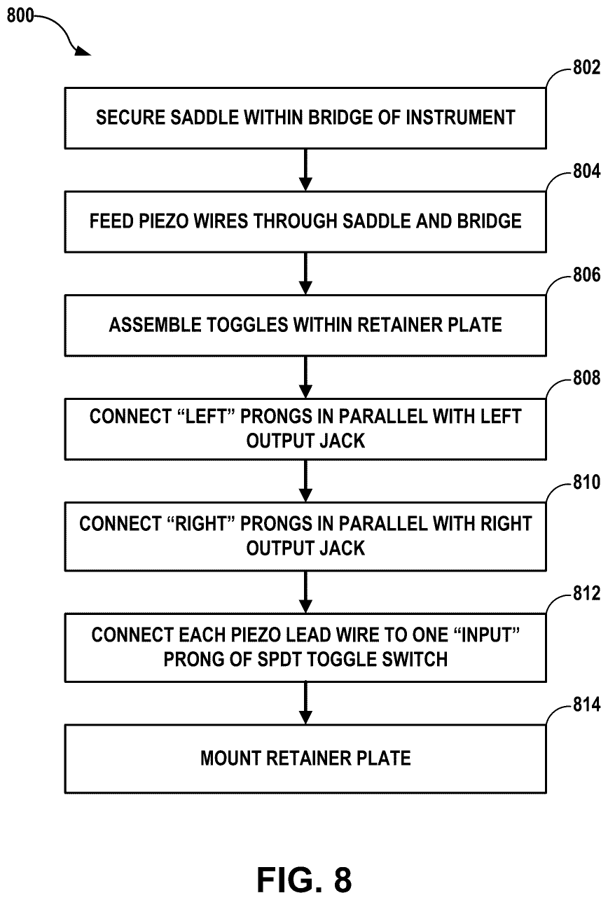

FIG. 8 is a flowchart illustrating an example method for assembling a polyphonic pickup system within a stringed musical instrument, in accordance with the techniques described herein, and with reference to the examples described above.

Step 802 includes securing an audio-pickup saddle 734 within the bridge 112 of the instrument 102. At Step 804, conductive wires coupled to audio-pickup device 110 (e.g., piezoelectric transducers) are fed through corresponding slots 736 of the saddle 734 and through the bridge 112 of the instrument 102, such that the pickup device 110 are aligned within the saddle 734.

Step 806 includes assembling a plurality of user-input devices 116, such as SPDT toggle switches 216, within respective apertures 740 of a retainer plate 738. Once secured, at Step 808, the “left” output prongs 226A of the plurality of input devices 116 are conductively coupled in parallel (326A) with a first audio-output device 108A. Similarly, at Step 810, the “right” output prongs 226B of the input devices 116 are conductively coupled in parallel (326B) with a second audio-output device 108B.

At Step 812, each conductive wire 114 is conductively coupled (e.g., soldered) to the “input” prong 224 of a respective input device 116, such as an SPDT toggle switch 216. Finally, at Step 814, the retainer plate 738 is secured to the body 528 or neck 530 of the instrument 102.

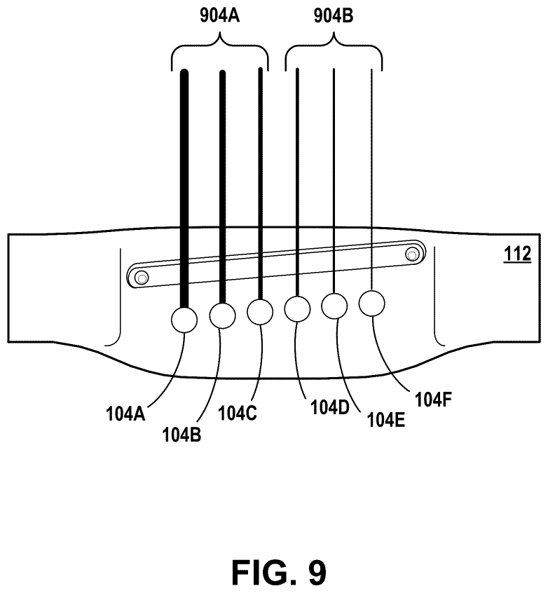

As introduced above, the polyphonic pickup systems of this disclosure enable the user to “split” the music produced by a single instrument into multiple distinct audio channels and direct them, at will, to different audio-output devices (e.g., speakers, headphones, earbuds). In the previous examples of pickup system 100, each individual string 104 of the instrument 102 formed an independent, non-overlapping subset of the instrument's music. In other examples of pickup system 100, the six strings 104A-104F of the instrument can be grouped into any two or more overlapping or non-overlapping subsets, wherein each string subset corresponds to an independent directable audio channel. For instance, FIG. 9 shows an example in which the six strings of a guitar are grouped into two non-overlapping subsets 904. Specifically, the three “bass” strings 104A-104C constitute a first subset of strings 904A, and the three “treble” strings 104D-104F constitute a second subset of strings 904B.

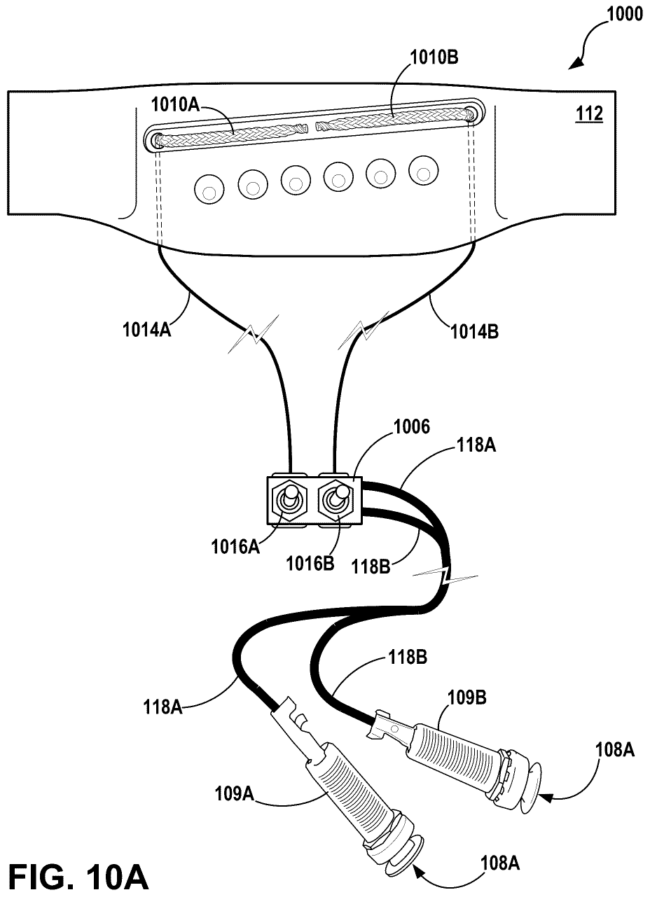

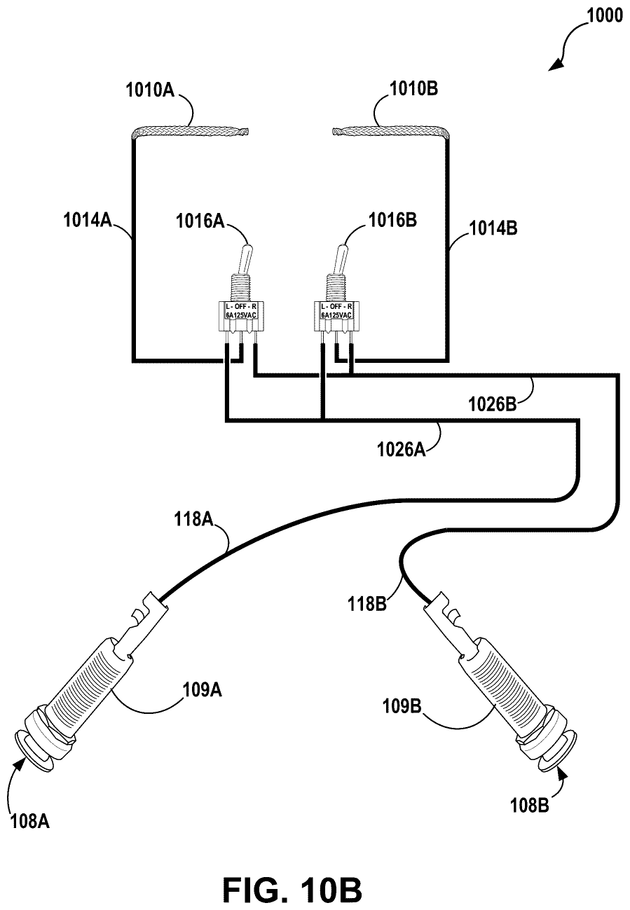

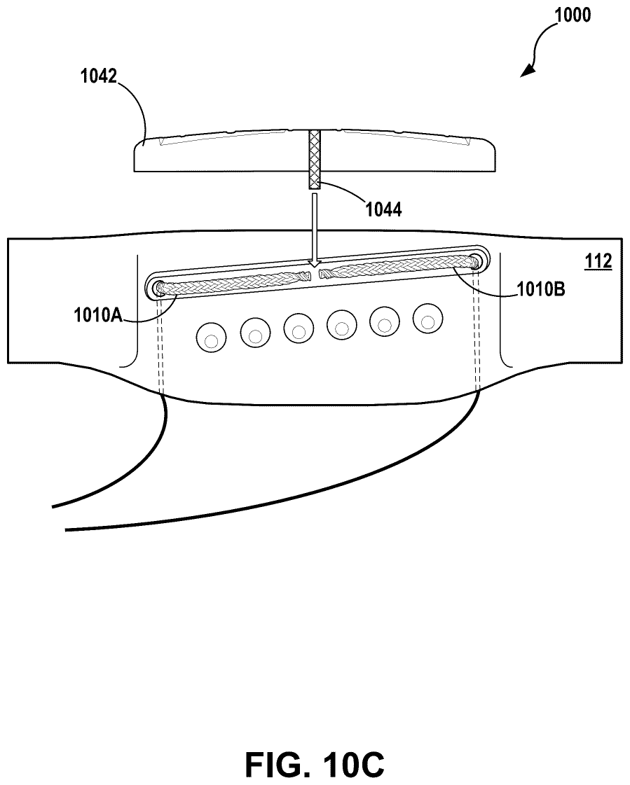

FIGS. 10A-10C illustrate an example polyphonic pickup system 1000 based on the string subsets 904A/904B shown in FIG. 9. In accordance with the prevailing techniques of this disclosure, for each string subset 904, polyphonic pickup system 1000 includes a respective audio-pickup device 1010 configured to generate and output a signal indicative of the music being produced by those strings. Accordingly, each of the audio-pickup devices 1010A, 1010B is configured to respond to multiple (e.g., three) strings 104 at the same time. That is, each audio-pickup device 1010 of system 1000 features a more elongated configuration than the compact “button”-type piezoelectric transducers 110 shown in the previous examples. In FIGS. 10A-10C, elongated pickup devices 1010 are depicted as “braided-rope”-type piezoelectric transducers. In other examples, one or more “bar”-type piezoelectric transducers, or any other suitable elongated audio-pickup device, may be used.

When wired according to the diagram shown in FIG. 10B, toggle switches 1016A, 1016B function the same as in the previous examples, providing the user with nine different permutations of selectable configurations for the “bass” string subset 904A and the “treble” string subset 904B, namely: “left-left,” “left-off,” “left-right,” “off-left,” “off-off,” “off-right,” “right-left,” “right-off,” and “right-right.”

As shown in FIG. 10C, system 1000 further includes a specialized saddle 1042 configured to fit between the strings 104 and the elongated pickups 1010A, 1010B. Specifically, saddle 1042 features a central insulator 1044 configured to acoustically isolate the two subsets of strings 904A/904B from each other. In some examples, the central insulator 1044 extends downward between the inner ends of the two braided pickups 1010A/1010B for the same purpose. The insulator can be formed from rubber or another suitably insulative material.

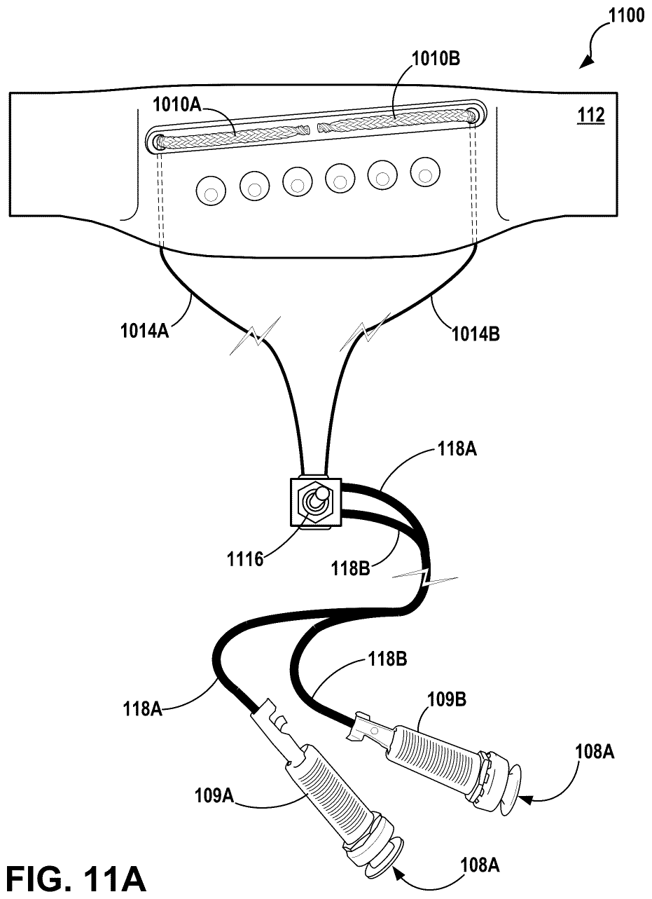

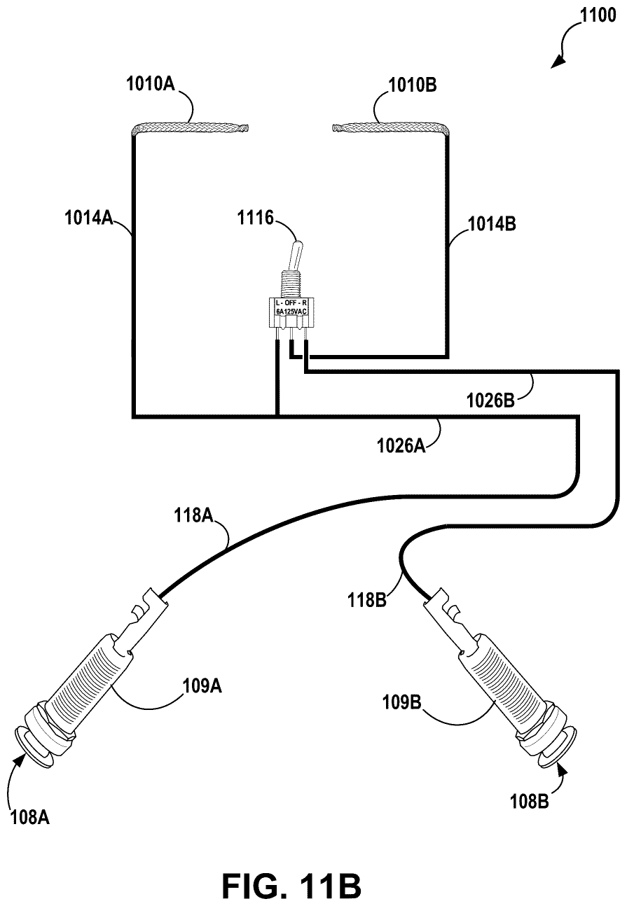

FIGS. 11A and 11B illustrate another example of pickup system 100, in which, just like the previous example, the six strings 104A-104F are divided into just two (non-overlapping) subsets of “bass” strings 904A and “treble” strings 904B. System 1100, however, features just one single user-input device 1116, providing the user with exactly three selectable configurations for the two audio channels. The format of these three configurations can vary, depending on the particular wiring configuration between the two audio-pickup devices 1010A/1010B and the user-input device 1116. The wiring diagram in FIG. 11B provides an example of one such configuration.

In the particular example shown in FIG. 11B, audio-pickup device 1010A is conductively coupled to the “left” output prong of toggle switch 1116, and audio-pickup device 1010B is conductively coupled to the center “input” prong. Accordingly, in this configuration, the bass strings 904A constitute a “non-selectable” subset of strings, in that their audio signal will always be transmitted to the “left” audio jack 109A.

Conversely, the treble strings 904B are actively selectable, via the three configurations of toggle switch 1116, between the left audio jack 109A, the right audio jack 109B, or neither (i.e., muted) when the toggle switch 1016 is in the central “off” position. Thus, the wiring configuration shown in FIG. 11B causes toggle switch 1116 to function as a mono/stereo audio switch. In the “left” position (e.g., FIG. 2A), the audio from all six strings is directed to a common output (i.e., mono-audio). In the “right” position (e.g., FIG. 2B), the bass signal and the treble signal are directed to separate channels (i.e., stereo-audio). Put differently, the three selectable configurations of toggle switch 1116 can be represented as “left-left,” “left-off,” and “left-right.”

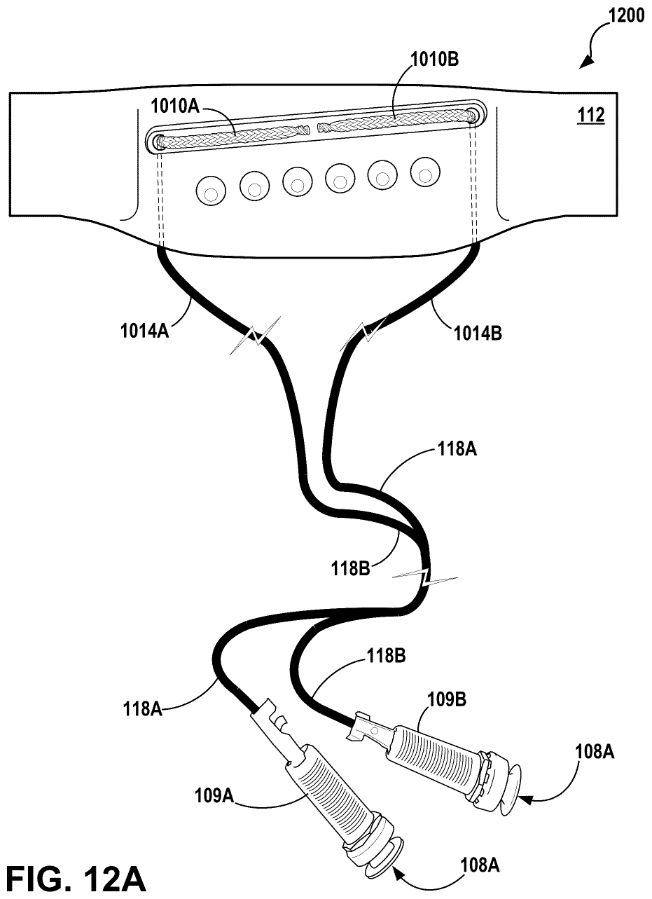

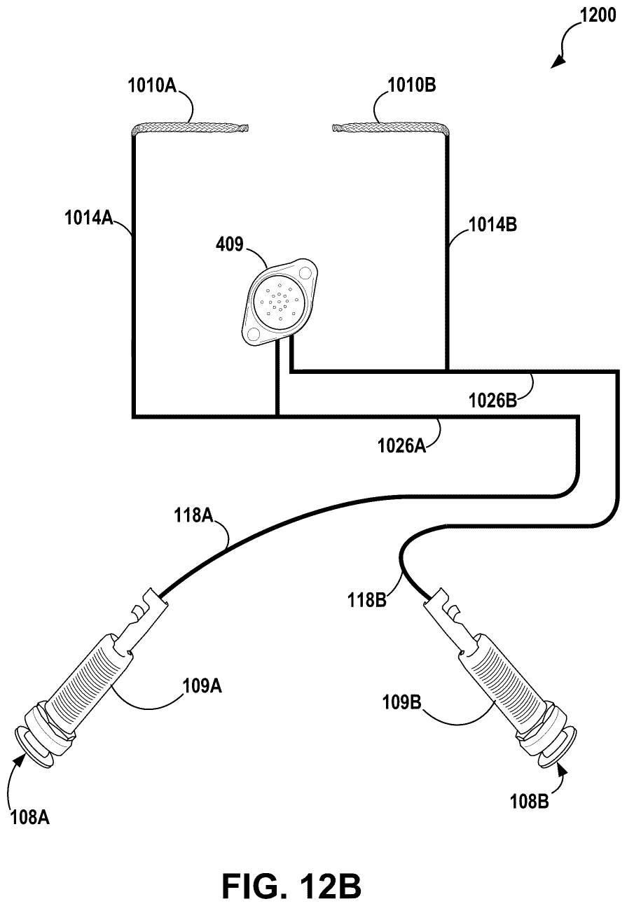

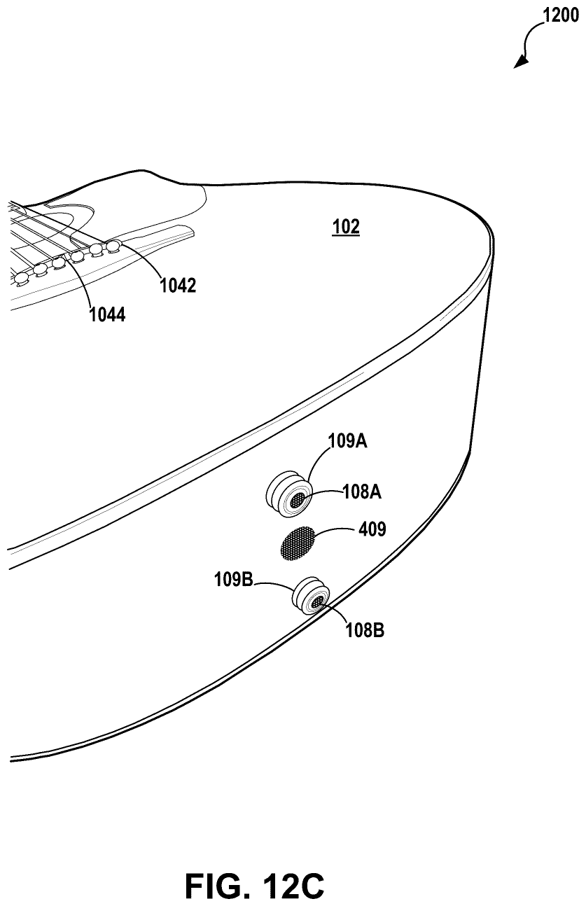

FIGS. 12A-12C illustrate another example of pickup system 100, in which, just like the previous two examples, the six strings 104A-104F are divided into just two (non-overlapping) subsets of “bass” strings 904A and “treble” strings 904B (FIG. 9). System 1200, however, features just no user-input devices. As shown in the wiring diagram in FIG. 12B, each string pickup device 1010 is wired directly to exactly one audio jack 109. When installed in an appropriate stringed instrument, polyphonic pickup system 1200 functions primarily to convert the instrument from a mono-audio device into a stereo-audio device. Thus, system 1200 provides particular convenience in the form of an easy-to-install kit that includes: the custom string saddle 1042 with acoustic divider 1044; two (or more) audio-pickup devices 1010A/1010B; two (or more) audio jacks 109A/109B; and optionally, a MIDI audio jack 409. In more advanced versions intended for installation by skilled practitioners, the kit can additionally include one or more user-input devices 216, as shown in previous examples.

The various examples recited above have been chosen, described, and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A polyphonic pickup system for a musical instrument having a plurality of strings, the system comprising:
two or more audio-pickup devices, each configured to output a signal indicative of music produced by a respective predetermined subset of the plurality of strings;
two or more audio-output devices; and
one or more user-input devices collectively defining two or more selectable configurations, the one or more user-input devices being communicatively coupled between the audio-pickup devices and the audio-output devices, such that each selectable configuration defines a unique coupling arrangement between the audio-pickup devices and the audio-output devices.

2. The system of claim 1, wherein at least one of the one or more user-input devices comprises a single-pole-double-throw (SPDT) toggle switch.

3. The system of claim 1, further comprising a wooden bridge defining an elongated central slot configured to retain the two or more audio-pickup devices.

4. The system of claim 1, wherein the predetermined subset of the plurality of strings for at least one of the two or more audio-pickup devices comprises two or more adjacent strings of the plurality.

5. The system of claim 4, wherein the at least one audio-pickup devices comprises an elongated piezoelectric transducer.

6. The system of claim 5, wherein the elongated piezoelectric transducer comprises a braided-rope-type transducer.

7. The system of claim 5, wherein the elongated piezoelectric transducer comprises a bar-type transducer.

8. The system of claim 1, further comprising a saddle positioned between the plurality of strings and the audio-pickup devices.

9. The system of claim 8, wherein the saddle comprises an insulator configured to acoustically insulate two non-overlapping string subsets of the predetermined subsets of the plurality of strings from one another.

10. The system of claim 9, wherein the insulator comprises a rubber block disposed between the two non-overlapping string subsets within the saddle.

11. The system of claim 9, wherein the insulator is further configured to extend between two adjacent ends of the two or more audio-pickup devices.

12. The system of claim 9, wherein the two non-overlapping string subsets comprise a first subset of three bass strings and a second subset of three treble strings, and wherein the insulator is centrally located within the saddle.

13. The system of claim 1, wherein:
the two or more audio-pickup devices comprise exactly two audio-pickup devices;
the predetermined subset of the plurality of strings for each audio-pickup device comprises exactly three strings;
the two or more audio-output devices comprise exactly two audio-output devices; and
the one or more user-input devices comprise exactly one user-input device defining exactly three selectable configurations.

14. The system of claim 13, wherein the unique coupling arrangements corresponding to the three selectable configurations comprise:
both of the two audio-pickup devices coupled to a first audio-output device of the two audio-output devices;
a first audio-pickup device of the two audio-pickup devices coupled to the first audio-output device, and a second audio-pickup device of the two audio-pickup devices coupled to a second audio-output device of the two audio-output devices; and
the first audio-pickup device coupled to the first audio-output device, and the second-audio pickup device coupled to neither of the two audio-output devices.

15. A stringed musical instrument comprising a polyphonic pickup system, the system comprising:
two or more audio-pickup devices, each configured to output a signal indicative of music produced by a respective predetermined subset of a plurality of strings of the instrument;
two or more audio-output devices; and
one or more user-input devices collectively defining two or more selectable configurations, the one or more user-input devices being communicatively coupled between the audio-pickup devices and the audio-output devices, such that each selectable configuration defines a unique coupling arrangement between the audio-pickup devices and the audio-output devices.

16. The instrument of claim 15, wherein the stringed musical instrument comprises a guitar, and wherein the plurality of strings comprises six strings.

17. The instrument of claim 15, wherein at least one of the two or more audio-pickup devices comprises a braided-rope-type piezoelectric transducer.

18. The instrument of claim 15, further comprising a saddle positioned between the plurality of strings and the audio-pickup devices, wherein the saddle comprises an insulator configured to acoustically insulate two non-overlapping string subsets of the predetermined subsets of the plurality of strings from one another.

19. The instrument of claim 18, wherein the two non-overlapping string subsets comprise a first subset of three bass strings and a second subset of three treble strings, and wherein the insulator is centrally located within the saddle.

20. The instrument of claim 15, wherein:
the two or more audio-pickup devices comprise exactly two audio-pickup devices;
the predetermined subset of the plurality of strings for each audio-pickup device comprises exactly three strings;
the two or more audio-output devices comprise exactly two audio-output devices; and
the one or more user-input devices comprise exactly one single-pole-double-throw (SPDT) toggle switch defining exactly three selectable configurations.
